(19) United States
(12) Patent Application Publication
(10) Pub. No.: US 2013/0290176 A1
(43) Pub. Date: Oct. 31, 2013

(54) TRANSACTION SERVICE PURCHASE OPTIONS VIA A PAYMENT PROVIDER

(71) Applicant: SESHAGIRI RAO TIRUMALASHETTY, Fremont, CA (US)

(72) Inventor: SESHAGIRI RAO TIRUMALASHETTY, Fremont, CA (US)

(73) Assignee: eBay, Inc., San Jose, CA (US)

(21) Appl. No.: 13/456,322

(22) Filed: Apr. 26, 2012

(51) Int. Cl. G06Q 40/00

(52) U.S. Cl. 705/40

(57) ABSTRACT

A request for payment for goods or services can be made to a payment provider. The payment provider can then provide the payer of the payment with access to a recommended list of service purchase options, based on the goods or services listed in the request for payment. The payer can sort the recommended list of service purchase options based on location of the service purchase option or service provider, type of service purchase option, customer reviews, price, popularity, etc. Upon selecting a particular service purchase option, the payer can pay for it using the services of the payment provider.

### BACKGROUND

1. Field of the Invention

The present invention generally relates to sales, marketing and transactions of services to a buyer based on prior, current or anticipated purchases of the buyer through a payment provider.

2. Related Art

Various sales techniques have evolved whereby a seller presents various options to a buyer or potential buyer based on their interest in a particular good or service. For example, “upselling” involves marketing upgraded or premium items, such as goods or services, to a consumer based on a related prior, current or anticipated purchase. Another common sales technique is “cross-selling” in which a seller tries to sell a customer related or complimentary items, such as goods or services, based on a related prior, current or anticipated purchase.

Consumers routinely purchase products and services from merchants, goods and service providers and individuals alike. Merchants, goods and service providers and individuals bill those that purchase from them, i.e., clients, consumers or buyers, via online, electronic mail or text-message invoicing or billing as well as at the location of the point of sale. No matter where these transactions occur, they can take place with the aid of a payment provider, such as PayPal, Inc. of San Jose, Calif. Such payment providers can make transactions easier and safer for the parties. Payment providers enable payments to be made through many different convenient methods.

When making a payment, the payer, buyer or consumer typically specifies a funding source for the payment such as an account with the payment provider, a credit card, a bank or checking account, or the like. When the payer, buyer or consumer specifies a funding source, the payment provider may process the payment request to determine whether the user has sufficient funds or credit to make the payment. If so, the payment request is approved, and the purchase is completed. However, if there are insufficient funds or credit, the payment request may be denied, resulting a lost sale for the seller or payee and a lost purchase or payment by the buyer or payer.

### SUMMARY

In one embodiment, the present invention describes an electronic payment processing system that includes a memory storing user account information, wherein the information includes funding sources for a user account and any restrictions on the funding sources, and one or more processors in communication with the memory configured to receive by a payment provider a request for a payment for a good or service, determine information about a payee, a payment amount and the payer, process the payment to the payee, and electronically send a URL to the payer which, when accessed, provides a selectable list of service purchase options related to the good or service from pre-selected service purchase providers. In some embodiments, the one or more processors in communication with the memory is further configured to transmit the status of the payment from the payment provider to the payer. In some embodiments, the selectable list of purchase items can be refined by the payers according to sorting criteria such as relevance, popularity, price, customer review, distance to a particular location, or a combination thereof. In some embodiments, the one or more processors in communication with the memory is further configured to notify a purchase provider that the payer has selected a particular purchase option. In some embodiments, the payment is for a purchase at a physical merchant point of sale location.

In one embodiment, the present invention describes a non-transitory machine-readable medium including a plurality of machine-readable instructions which when executed by one or more processors of a server are adapted to cause the server to perform a method including receiving a request for a payment for a good or a service by a payer to a payee, receiving authorization from the payer to access account information with a payment provider, processing the payment by transferring funds from the payer's account to a payee account, and electronically sending the payer service purchase options related to the good or service. In some embodiments, the method further includes electronically sending the payer confirmation of the transfer of funds. In some embodiments, the method further includes compiling a list of providers of the purchase options. In some embodiments, the method further includes receiving a request for a payment by the payer to a purchase option provider after the payer has selected a purchase option, receiving authorization from the payer to access account information with a payment provider, and processing the payment by transferring funds from the payer's account to a purchase option provider account. In some embodiments, the method further includes notifying a purchase option provider of a payee's selection of a particular purchase option. In some embodiments, the payment is for a purchase at a physical merchant point of sale location

In one embodiment, the present invention describes a method including receiving, electronically by a processor of a payment provider, a request for a payment for a good or service, determining information about a payer, a payee, and a payment amount, determining whether the payer has an account with the payment provider that can be used to make the payment, processing the payment to the payee, and presenting the payer with at least one service purchasing option related to the good or service, the information on the payer, the information on the payee, or a combination thereof. In some embodiments, the method further includes setting up an account for the payer with the payment provider if the payment provider determines that the payer doesn't have an account or that the payer's account is invalid. In some embodiments, the method further includes processing a payment for a purchasing option selected by the payer. In some embodiments, the method further includes notifying the provider of the purchasing option that the payer selected. In some embodiments, the purchasing option includes a service contract, extended warranty, maintenance agreement, or a combination thereof In some embodiments, the method further includes searching for a purchasing option related to the request for payment based on the location of the payee or the payer. In some embodiments, the at least one purchasing option is presented to the payer based on the location of the option with respect to the payer, the reviews of the at least one purchasing option, the type of purchasing option, the location of the point of sale, or a combination thereof, based on the preference of the payer. In some embodiments, the method further includes sending a confirmation of the payment to the payer. In some embodiments, presenting the payer with at least one purchasing option includes placing a hyperlink in the confirmation of payment. In some embodiments, the method further includes recommending other alternative purchasing options to the payer if the payer declines the use of at least one other purchasing option. In some embodiments, the at least one purchasing option is presented to the payer from a pool of screened or filtered options. In some embodiments, the payment is for a purchase at a physical merchant point of sale location

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for a payment provider in processing a request for payment, ascertaining services related to the request for payment, constructing an engine containing the service purchase options for the related services and presenting it to a payer according to one embodiment of the invention;

FIG. 2 is a flowchart showing a process of presenting, selecting and paying for a service purchase option related to the original request for payment according to one embodiment of the invention;

FIG. 3 is block diagram of a networked system suitable for implementing the process of FIGS. 1 and 2 according to an embodiment; and

FIG. 4 is a block diagram of a system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present invention provides consumers with the option to purchase services related to items, goods or services that they have already purchased, are currently purchasing or are anticipating that they will purchase, with the use of a payment provider. Accordingly, the present invention allows a payment provider to provide its customers with additional service purchasing options related to their original purchase. These additional service purchasing options may be pre-screened by the payment provider or another company so that the buyer is presented with a recommended list of options. The point of sale and payment for the original purchase through a payment provider account may take place online or within a particular store.

The methods and systems of the present invention provide offers for supplementary services (“upsells” or “cross-sells”) which are individually customized to be more desirable and acceptable to each customer, rather than service offers which are provided to every customer. The offers, if accepted, can provide the customer with immediate gratification, for example, by providing access to a particular service without having to research these additional services independently.

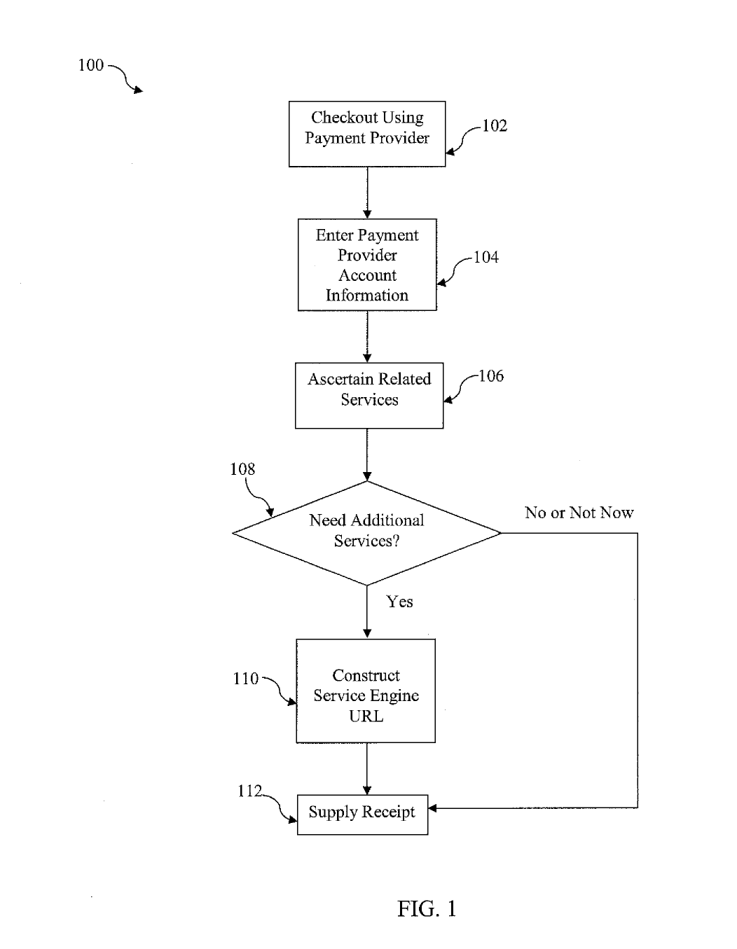

FIG. 1 is a flowchart 100 showing a process in determining and offering services to a buyer or payer related to an initial purchase wherein payment is made through a payment provider. Initially, the buyer or payer purchases goods and/or services either in a store or electronically, such as via the Internet (step not shown). The initial goods and/or services can be any type or number of items and can cost any amount. The goods and/or services can be localized to where the buyer or payer is located, but, particularly if purchased online, can be purchased from a seller or payee that is located anywhere in the world.

The buyer or payer checks out and pays for at least a portion of the goods and/or services using a payment provider such as PayPal, Inc. of San Jose, Calif. This may occur at a salesperson accessible interface or may be an online or self checkout process. The payment provider transfers funds from a buyer or payer account to a merchant, seller, retailer, provider, individual (collectively “payee”). At step 102, the buyer or payer selects the payment provider as their preferred method of payment for the goods and/or services. A request for payment or invoice by the buyer or payer is sent to the payment provider. The request can be sent via the payee to the payment provider, typically through a payee's account with the payment provider. The request for payment and/or the checkout process can be accomplished through use of a personal computer (PC), laptop, mobile phone, smart phone, computing tablet, checkout machine, or other computing device. The request for payment may be for the full amount of the invoice or it may be for a partial amount of the invoice. Upon submitting the request for payment to the payment provider, the payment provider receives transaction information. Transaction information may include buyer identification, payee identification, including a merchant account identifier, and invoice information, including, for example, price, tax, shipping costs, and totals. The transaction information may be received by an indication that the buyer is ready for checkout or payment of selected invoice(s).

At step 104, the buyer enters identifying payment provider account information. This can consist of information such as the buyer's telephone number, personal identification number (PIN), username, email address, phone number, credit card information, bank information, password, address, etc. It is at this step that it is determined whether the buyer has an account with the payment provider. This can be done by searching an account database of the payment provider with the buyer information. Tithe buyer doesn't have an account with a payment provider, then the buyer is notified that no account exists for them to make the payment. The buyer can then determine whether to create a payment provider account. If no account exists, the buyer may be asked to enter information again, as the original information may have been entered incorrectly. If still no account is found, an account may be created or registered. To register or create an account, the buyer typically enters the payment provider site, such as through a PC, laptop, smart phone, computing tablet, or other computing device. Alternatively, the account may be created at a point of sale terminal. Account creation may include the payment provider requesting certain information from the buyer, such as a username, email address, phone number, credit card information, bank information, PIN, password, and/or address. Using the requested information, the payment provider creates an account for the buyer. Note that if an account was found, but not valid, such as expired funding source, expired account, etc., the payment provider may only need to request a limited amount of information to re-activate the account, such as a valid funding source. Without a response or with an affirmative indication that the buyer does not want to open an account, the process ends.

If the buyer wants to pay only a partial amount of the invoice, then the buyer may need to enter an amount to be paid. Optionally, the buyer may also indicate a particular funding source to deduct the amount from. When the buyer enters identifying payment provider account information, the payment provider is able to access the account. Accessing the account allows the payment provider to determine certain information about the buyer and/or the account, such as account limits or restrictions, available funding sources, etc. It also enables the payment provider to make any determinations about the authenticity of the buyer. Optionally, the payment provider determines funding options for the buyer and the transaction, such as based on the buyer information and/or the transaction information. For example, the buyer may have specific funding options associated with the account. Conventional funding options may include a buyer bank/checking account and one or more credit cards. The buyer may also have limits to these conventional funding options, such as limits imposed by the instrument or a buyer controlling the instrument. Based on the funding sources provided by the payment provider, the buyer selects one or more funding sources as payment for the transaction. Selection may be by simply checking a box next to desired ones of the funding sources or other selection means, such as clicking on the desired funding source. The selected funding source(s) are then communicated to and received by the payment provider.

At step 106, the payment provider determines the type of goods and/or services that the buyer has purchased and ascertains related available services that the buyer may be interested in receiving and/or purchasing. For example, if the buyer has purchased a boiler from a home supply store, the payment provider could determine that the buyer may be interested in finding a service to install the boiler, or buying boiler warranties. A further example is when a buyer or payer buys a washing machine and therefore may have need for a handyman to install the washer. The buyer or payer selecting the services of a handyman to install the washer may then further need the services of a mover to remove the old washer. Other examples include a buyer or payer buying paint may have a need for a painter, a buyer or payer buying spark plugs may need a mechanic, or a buyer or payer buying audio/visual components may need an installer. This can be accomplished by accessing a database of related services. Related service purchase options can include performance of a particular service such as installation, painting, building, moving, general contractor work, gardening, landscaping, etc., or service contract(s), extended warranty(s), maintenance agreement(s), or a combination thereof. The database may contain only services or service providers that have been pre-screened by the payment provider or another company so as to contain only recommended or subscribed companies and/or services. The database can be pre-sorted by the payment provider or sorted by the stated preferences of the buyer. The related services can be localized to a particular geographic location, such as where the original goods and/or services were purchased, where the buyer is located or where the seller is located. This can be determined based on the zip code of these locations or by GPS technology. Alternatively, or in addition, the related services can be initially sorted by relevance or category type such as installation, warranties, movers, deliveries, etc. The buyer would then be able to select the type of service that they wish to view service purchase options for. Typically, these service purchase options would be provided for by service providers local to the buyer. The buyer would then be able to purchase a selected service, contact the service provider, obtain more information about the service, or a combination thereof.

At step 108, the buyer is presented with the option of whether or not they would like to view the additional services as determined by the payment provider. This option can be presented in any number of ways, such as verbally from a salesperson, electronically on a checkout keypad or online when checking out through use of the payment provider website. Typically, the buyer can indicate whether they want to view the additional services by clicking on an icon such as “Yes,” “No” or “Not Now.” In one embodiment, step 108 occurs prior to the payment provider ascertaining the related goods and/or services at step 106.

Should the buyer decide that they do not want to view the additional services, the buyer would typically click on the “No” or “Not Now” icon. The payment provider would then determine whether to approve the payment. The determination process may include checking on limits or restrictions associated with the buyer's account, the details of the transaction or purchase, and the availability of one or more selected funding sources. Any number of reasons may cause the transaction to be declined, such as any indication of a fraudulent transaction, the type of transaction, purchase, or merchant was specifically forbidden, spending limits have been reached or exceeded, and/or insufficient funds for the transaction amount. For example, the buyer may have selected one or more funding sources that are not available for this transaction or the funding sources selected are insufficient to fund the transaction amount.

If the requested payment is not approved, the buyer may have the option of re-submitting the request by changing one or more parameters, such as adding a funding source and/or changing a funding source. If the buyer wishes to re-submit the request, the buyer re-submits the request to pay the invoice and the payment provider may receive new funding sources. Processing of the payment would then continue. If the buyer does not wish to re-submit the request or the buyer is not given the option of re-submitting (such as in the case where the reason for not approving the transaction was based on the actual type of transaction), then the transaction ends without a payment. Optionally, the merchant and/or buyer is notified that the transaction has not been completed.

However, if the transaction request is approved, the payment provider processes the payment. The processing may include debiting the appropriate amount of funds from each of the specified funding sources and/or accounts, crediting the appropriate amount of funds to the merchant and making the full or partial amount is deducted from the buyer's account or funding source.

If the buyer clicks on the “No” icon, then the buyer may be provided with a receipt at step 112. If the buyer clicks on the “Not Now” icon, the payment provider may send a message to the buyer later on that asks the buyer whether they would like to view the additional service options. Optionally, a receipt for the original purchase is supplied to the buyer at step 112. The receipt may be sent through email, text, phone call, or notification on the buyer's or merchant's account page with the payment provider. If the buyer decides that they wish to view the additional service options by clicking “Yes”, then the payment provider provides the buyer with a URL or URI to the additional service options or to an additional services search engine at step 110. This may be in the form of a hyperlink, if the transaction is taking place online. At step 112, the full or partial amount is deducted from the buyer's account and optionally, a receipt for the original purchase is provided to the buyer. The receipt can be a physical print out or it can be an electronic receipt that is received via the payment provider or seller's website or through email, text message, etc. In some embodiments, the receipt for the original purchase contains the URL, URI or hyperlink to the additional items or search engine. In some embodiments, the search engine is provided for by a different company than the payment provider.

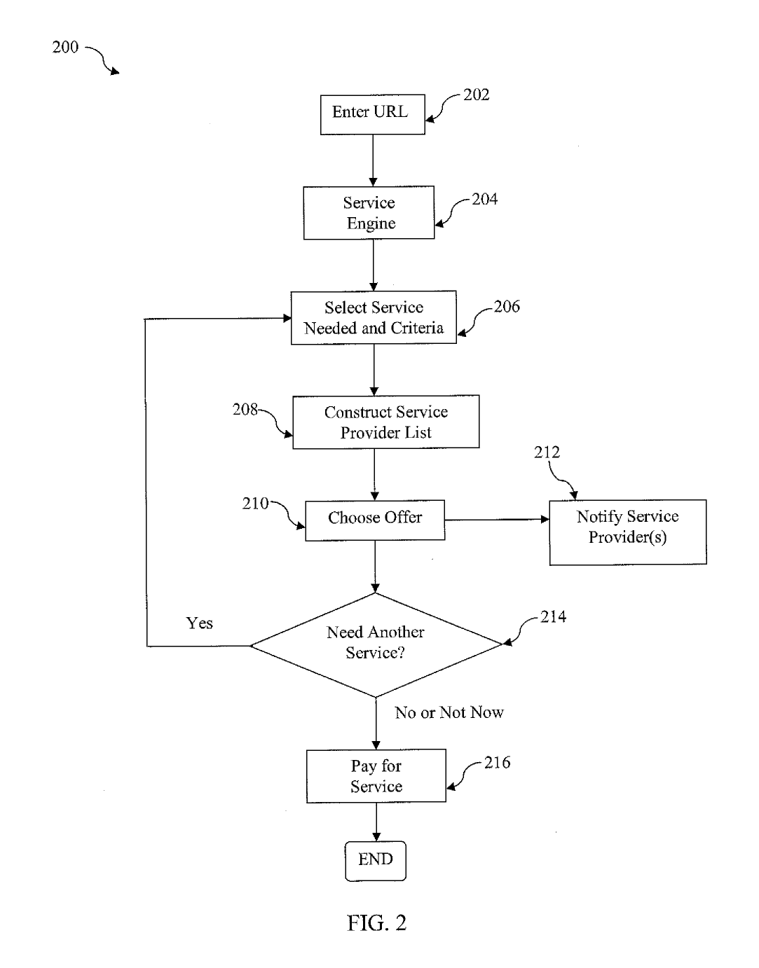

FIG. 2 is a flowchart 200 showing a process for a buyer to make a purchase of additional service(s) according to one embodiment. At step 202, the buyer enters the URL or URI or clicks on the hyperlink provided by the payment provider. This can be accomplished through any device that can access the Internet, such as a personal computer (PC), laptop, mobile phone, smart phone, computing tablet, checkout machine, or other computing device. In one embodiment, at step 204, the URL, URI or hyperlink links to a webpage containing a services search engine. The search engine can contain broad categories from which the buyer can choose from, or can contain narrower categories, topically related to the original purchase.

At step 206, the buyer selects the service desired and any relevant searching criteria. Searching criteria can include, but is not limited to, search terms, and results can be filtered or sorted by the buyer or the payment provider according to distance from a particular location, relevance, popularity, customer review, pricing, date good or service required, best match, category, etc.

After the buyer has made their selections, a service provider list is constructed at step 208. The providers are those entities that have been pre-screened or recommended by the payment provider or a company working or contracted with the payment provider. In some embodiments, a multitude of providers are listed and in some embodiments one provider is listed. In some embodiments, no providers are listed, but the services are listed. The buyer may contact the providers to further refine their request(s). This may occur through the payment provider website. Alternatively, or additionally, the providers may place bids for the fulfillment of the buyer's request(s).

At step 210, the buyer selects a service offer that the buyer wishes to purchase. At step 212, the service provider(s) is notified that the buyer has purchased a particular service offer. Optionally, the other service providers are notified that the buyer has not chosen to purchase their offers.

Optionally, at step 214, the buyer is questioned whether another related service is needed. If the buyer does want to purchase or price out another service, the buyer typically clicks on a “Yes” icon and the process repeats. If the buyer does not want to purchase or price out another service, then the buyer typically clicks on a “No” or “Not Now” icon and proceeds to checkout, typically with the payment provider, as described above. If the buyer clicks on a “Not Now” icon, then the payment provider may contact the buyer at some point after the completion of the transaction.

Therefore, using embodiments of the present invention, a buyer may be able to make an additional related purchase, where in the past, the buyer would be unaware of the option to purchase such a service or would have to conduct their own independent search for such a service. This results in a purchase and payment that otherwise may not have happened.

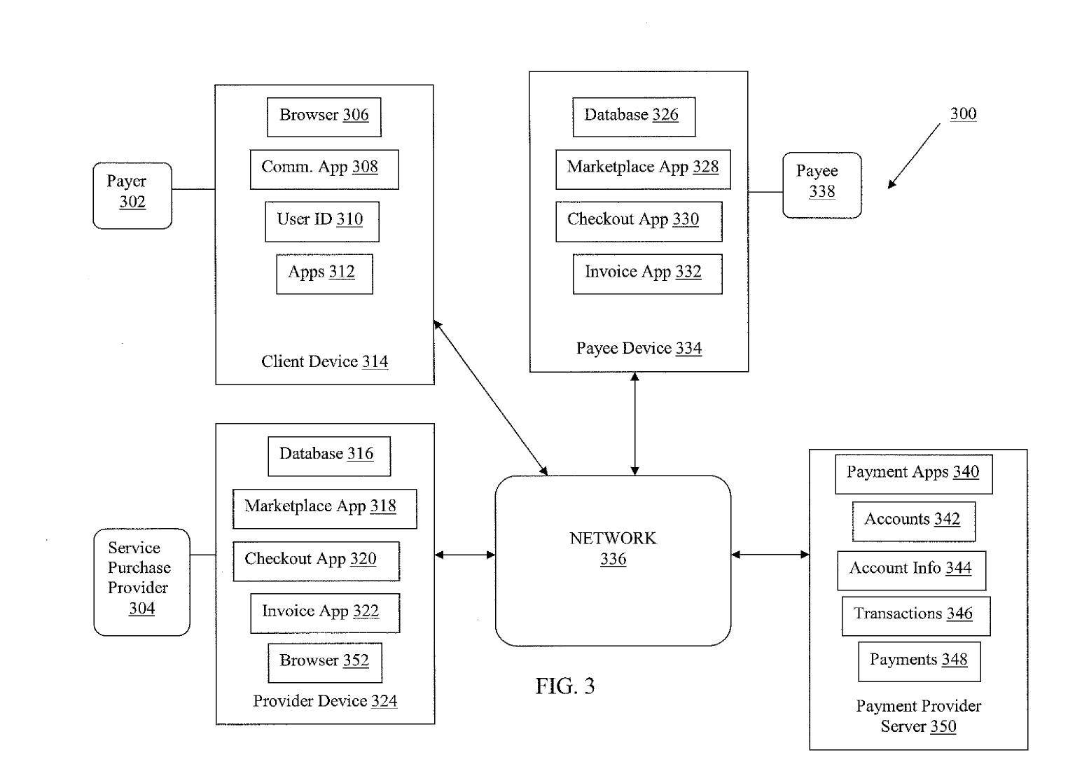

FIG. 3 is a block diagram of a networked system 300 configured to handle a financial transaction between a merchant or payee 338, a buyer or payer 302, and a service purchase provider 304 such as described above, in accordance with an embodiment of the invention. System 300 includes a client device 314, a provider device 324, a payee device 334, and a payment provider server 350 in communication over a network 336. Payment provider server 350 may be maintained by a payment provider, such as PayPal, Inc. of San Jose, Calif. A payer 302, utilizes client device 314, a service purchase provider 304, such as a merchant, consultant or contractor, utilizes a provider device 324 and a payee 338, such as a merchant, utilizes a payee device 334. The payee 338 and the provider 324 may be different entities but in some instances may be the same entity or company.

Client device 314, provider device 324, payee device 334, and payment provider server 350 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 336.

Network 336 may be implemented as a single network or a combination of multiple networks. For example, in various embodiments, network 336 may include the Internet or one or more intranets, landline networks, wireless networks, and/or other appropriate types of networks.

Client device 314, provider device 324 and payee device 338 may be implemented using any appropriate hardware and software configured for wired and/or wireless communication over network 336. For example, in one embodiment, the devices may be implemented as a personal computer (PC), a smart phone, a mobile phone, personal digital assistant (PDA), laptop computer, and/or other types of computing devices capable of transmitting and/or receiving data, such as an iPad™ from Apple™.

Client device 314 may include one or more browser applications 306 which may be used, for example, to provide a convenient interface to permit payer 302 to browse information available over network 336. For example, in one embodiment, browser application 306 may be implemented as a web browser configured to view information available over the Internet. Client device 314 may also include one or more applications 312 which may be used, for example, to provide client-side processing for performing desired tasks in response to operations selected by buyer 302. In one embodiment, a toolbar application may display a user interface in connection with browser application 306 as further described herein. Client device 314 may further include other applications 312 as may be desired in particular embodiments to provide desired features to first client device 314. For example, other applications 312 may include security applications for implementing client-side security features, programmatic client applications for interfacing with appropriate application programming interfaces (APIs) over network 328, or other types of applications. Applications 312 may also include email, texting, voice and IM applications that allow buyer 302 to send and receive emails, calls, and texts through network 328, as well as applications that enable the buyer to arrange to make payments through the payment provider as discussed above. Client device 314 includes one or more user identifiers 310 which may be implemented, for example, as operating system registry entries, cookies associated with browser application 306, identifiers associated with hardware of client device 314, or other appropriate identifiers, such as used for payment/user/device authentication. In one embodiment, user identifier 310 may be used by a payment service provider to associate buyer 302 with a particular account maintained by the payment provider as further described herein. A communications application 308, with associated interfaces, enables client device 314 to communicate within system 300 and may be used to send a message or request to the provider or payment provider.

The provider device 324 may be maintained, for example, by a merchant or seller offering various products and/or services in exchange for payment to be received over network 336. Generally, the provider device 324 may be maintained by anyone or any entity that receives money, which includes charities as well as retailers. Provider device 324 may have similar applications and modules as client device 314, but is used, in this example, for receiving requests by buyer 302 via the client device 314 or via the payment provider and for sending invoices through use of a payment provider. Provider device 324 may also include one or more browser applications 352 and one or more applications which may be used, for example, to provide a convenient interface to permit service purchase provider 304 to browse information and perform tasks over network 336. For example, in one embodiment, browser application 352 may be implemented as a web browser configured to view information available over the Internet and communicate with payment provider server 350 to receive and send information about a provider invoice based on a request from a payer 302.

Provider device 324 may further include other applications such as security applications for implementing client-side security features, programmatic client applications for interfacing with appropriate application programming interfaces (APIs) over network 336, or other types of applications. Applications may also include email, text, IM, and voice applications that allow service purchase provider 304 to communicate through network 336, receive messages from buyer 302, and create and manage account information. Provider device 316 includes one or more user identifiers which may be implemented, for example, as operating system registry entries, cookies associated with browser application 352, identifiers associated with hardware of provider device 324, or other appropriate identifiers, such as used for payment/provider/device authentication, e.g., the phone number associated with provider device 316. Identifiers may be used by a payment service provider to associate service purchase provider 304 with a particular account maintained by the payment service provider.

Provider device 324 may further include a database 316 identifying available products and/or services (e.g., collectively referred to as “items”) which may be made available for viewing and purchase by payer 302. Accordingly, the provider device 324 also includes a marketplace application 318 which may be configured to serve information over network 336 to browser 306 of client device 314. In one embodiment, buyer 302 may interact with marketplace application 318 through browser applications over network 336 in order to view various products or services identified in database 316.

The provider device 324 also may include a checkout application 320 which may be configured to facilitate the purchase by buyer 302 of goods or services identified by marketplace application 318. Checkout application 320 may be configured to accept payment information on the buyer 302 through payment service provider server 350 over network 336. For example, checkout application 320 may receive and process a payment confirmation from payment service provider server 350, as well as transmit transaction information to the payment provider and receive information from the payment provider (e.g., a transaction ID). Checkout application 320 may also be configured to accept one or more different funding sources, including funding sources, for payment.

The provider device 324 may also include an invoice application 322 which may be configured to bill the buyer 302 for the provision of goods and services. The invoice application 322 may bill the buyer 302 once or on a routine basis. The invoice application 322 may transmit information to the buyer 302 via the client device browser 306, any application 312 and/or communication application 308.

The payee device 334 may be maintained, for example, by a merchant or seller offering various products and/or services in exchange for payment to be received over network 336. Generally, the payee device 334 may be maintained by anyone or any entity that receives money, which includes charities as well as retailers. The payee device 334 includes a database 326 identifying available products and/or services (e.g., collectively referred to as “items”) which may be made available for viewing and purchase by payer 302. Accordingly, the payee device 334 also includes a marketplace application 328 which may be configured to serve information over network 336 to browser 306 of client device 314. In one embodiment, buyer 302 may interact with marketplace application 328 through browser applications over network 336 in order to view various products or services identified in database 326.

The payee device 334 also may include a checkout application 330 which may be configured to facilitate the purchase by buyer 302 of goods or services identified by marketplace application 328. Checkout application 330 may be configured to accept payment information on the buyer 302 through payment service provider server 350 over network 336. For example, checkout application 330 may receive and process a payment confirmation from payment service provider server 350, as well as transmit transaction information to the payment provider and receive information from the payment provider (e.g., a transaction ID). Checkout application 330 may also be configured to accept one or more different funding sources, including funding sources, for payment.

The payee device 334 may also include an invoice application 332 which may be configured to bill the buyer 302 for the provision of goods and services. The invoice application 332 may bill the buyer 302 once or on a routine basis. The invoice application 332 may transmit information to the buyer 302 via the client device browser 306, any application 312 and/or communication application 308.

Payment provider server 350 may be maintained, for example, by an online payment service provider which may provide payment between buyer 302 and the operator of the payee device 334, as well as between buyer 302 and the operator of the provider device 324.

In this regard, payment provider server 350 includes one or more payment applications 340 which may be configured to interact with client device 314, provider device 324, and/or payee device 334 over network 336 to facilitate the payment for goods or services rendered to buyer 302.

Payment provider server 350 also maintains a plurality of user accounts 342, each of which may include account information 344 associated with individual users. For example, account information 344 may include private financial information of users of devices such as account numbers, passwords, device identifiers, user names, phone numbers, credit card information, bank information, or other financial information which may be used to facilitate online transactions by payer 302 and optionally, by service purchase provider 304 and payee 338. Advantageously, payment application 340 may be configured to interact with payee device 334 on behalf of payer 302 during a transaction with checkout application 330 to track and manage purchases made by payer 302 and which funding sources are used.

A transaction processing application 346, which may be part of payment application 340 or separate, may be configured to receive information from a client device and/or provider device 324 and payee device 334 for processing and storage in a payment database 348. Transaction processing application 346 may include one or more applications to process information from buyer 302 for processing a payment using a buyer's funding source as described herein. Other funding sources may also be processed through this application. Payment application 340 may be further configured to determine the existence of and to manage accounts for payer 302, and optionally service purchase provider 304, and payee 338, as well as create new accounts if necessary, such as the set up, management, and use of various funding sources.

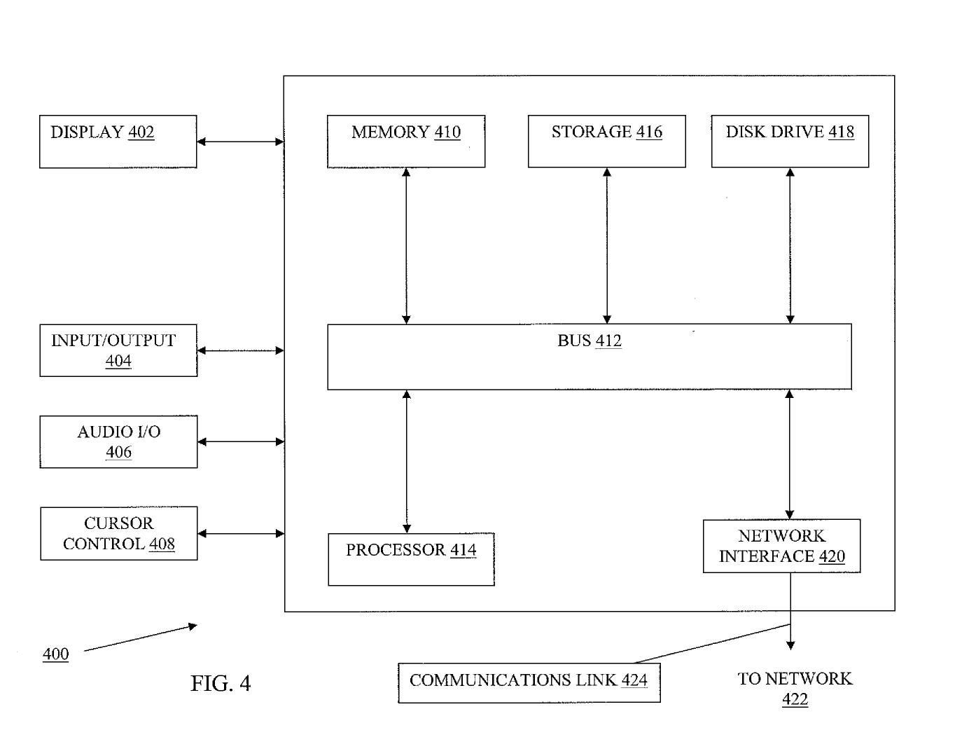

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The payee, provider and/or payment provider may utilize a network computing device (e.g., a network server) capable of communicating with the network. It should be appreciated that each of the devices utilized by payers, payees, and providers (i.e., merchants), and payment providers may be implemented as computer system 400 in a manner as follows.

Computer system 400 includes a bus 412 or other communication mechanism for communicating information data, signals, and information between various components of computer system 400. Components include an input/output (I/O) component 404 that processes a user (i.e., payer, payee, service provider and/or payment provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a merchant server, or a payment provider server via network 328. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. The above description focuses on a payment provider providing access to its clients for items related to goods and/or services that the clients have already purchased. However, the original payment or request for payment need not be for a generated invoice, but can be for an intended or anticipated purchase in which an invoice has not yet been created. For example, a buyer may want to purchase an item from a merchant, where the item is placed in a cart, but not yet paid for. Thus, different types of requests for payment by a buyer may also be suitable. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic payment processing system comprising:
a memory storing user account information, wherein the information comprises funding sources for a user account and any restrictions on the funding sources; and
one or more processors in communication with the memory configured to
receive by a payment provider a request for a payment for a good or service;
determine information about a payee, a payment amount, and a payer;
process the payment to the payee; and
electronically send a URL to the payer which, when accessed, provides a selectable list of service purchase options related to the good or service from pre-selected service purchase providers.

2. The system of claim 1, wherein the list of service purchase options comprises a service contract, extended warranty, maintenance agreement, or a combination thereof.

3. The system of claim 1, wherein the selectable list of service purchase items can be refined by the payer according to sorting criteria such as relevance, popularity, price, customer review, distance to a particular location, or a combination thereof.

4. The system of claim 1, wherein the one or more processors in communication with the memory is further configured to notify a service purchase provider that the payer has selected a particular service purchase option.

5. The system of claim 1, wherein the payment is for a purchase at a physical merchant point of sale location.

6. A non-transitory machine-readable medium comprising a plurality of machine-readable instructions which when executed by one or more processors of a server are adapted to cause the server to perform a method comprising:
receiving a request for a payment for a good or a service by a payer to a payee;
receiving authorization from the payer to access account information with a payment provider;
processing the payment by transferring funds from the payer's account to a payee account; and
electronically sending the payer service purchase options related to the good or service.

7. The non-transitory machine-readable medium of claim 6, wherein the service purchase options are localized to the payer's geographic area.

8. The non-transitory machine-readable medium of claim 6, further comprising compiling a list of service providers of the service purchase options.

9. The non-transitory machine-readable medium of claim 6, further comprising:
receiving a request for a payment by the payer to a service purchase option provider after the payer has selected a service purchase option;
receiving authorization from the payer to access account information with a payment provider; and
processing the payment by transferring funds from the payer's account to a service purchase option provider account.

10. The non-transitory machine-readable medium of claim 6, further comprising notifying a service purchase option provider of a payer's selection of a particular service purchase option.

11. A method comprising:
receiving, electronically by a processor of a payment provider, a request for a payment for a good or service;
determining information about a payer, a payee, and a payment amount;
determining whether the payer has an account with the payment provider that can be used to make the payment;
processing the payment to the payee; and
presenting the payer with at least one service purchasing option related to the good or service, the information on the payer, the information on the payee, or a combination thereof

12. The method of claim 11, wherein the payment is for a purchase at a physical merchant point of sale location.

13. The method of claim 11, further comprising processing a payment for a service purchasing option selected by the payer.

14. The method of claim 11, further comprising notifying the service provider of the service purchasing option that the payer selected.

15. The method of claim 11, wherein the service purchasing option comprises a service contract, extended warranty, maintenance agreement, or a combination thereof.

16. The method of claim 11, further comprising searching for a service purchasing option related to the good or service based on the location of the payer or the payee.

17. The method of claim 11, wherein the at least one service purchasing option is sorted and presented to the payer based on the location of the service provider with respect to the location of the payer, the reviews of the at least one service purchasing option or service provider, the type of service purchasing option, the location of the point of sale, or a combination thereof, based on the preference of the payer.

18. The method of claim 11, wherein the payment is for a purchase at a physical merchant point of sale location.

19. The method of claim 11, wherein presenting the payer with at least one service purchasing option comprises placing at least one hyperlink in the confirmation of payment.

20. The method of claim 11, further comprising recommending other alternative service purchasing options to the payer if the payer declines the use of at least one other service purchasing option.

21. The method of claim 11, wherein the at least one service purchasing option is presented to the payer from a pool of screened or filtered options.
